(19) United States
(12) Patent Application Publication
(10) Pub. No.: US 2011/0015980 A1
(43) Pub. Date: Jan. 20, 2011

(54) System and Method For Managing Promotions Within An Online Stationery Design System

(76) Inventor: Justin LI, San Mateo, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/505,979

(22) Filed: Jul. 20, 2009

(51) Int. Cl. G06Q 30/00; G06Q 50/00; G06F 3/048

(52) U.S. Cl. 705/14.23; 715/780; 715/762; 715/843

(57) ABSTRACT

A system and method are described for managing promotions within an online stationery service. For example, a system implemented in accordance with one embodiment of the invention comprises a promotions engine for creating and managing promotions related to online stationery, the promotions engine comprising: a plurality of promotion rules associated with a plurality of stationery promotions, each of the promotion rules comprising one or more condition objects and one or more clause objects, each of the condition objects comprising at least a specified condition level variable, the condition level variable having a plurality of selectable options including an order level and an item level, wherein order level indicates that the condition is applicable to an entire online stationery order and item level indicates that the condition is applicable to a particular stationery item or group of related items, wherein each condition level has a value associated therewith to indicate a minimum dollar amount or quantity of stationery to meet the condition; each of the clause objects comprising at least a specified clause level variable, the clause level variable having a plurality of selectable options including an order level and an item level, wherein order level indicates that the clause is applicable to an entire stationery order and item level indicates that the clause is applicable to a particular stationery item or group of related items, wherein each clause level has a value associated therewith to indicate a dollar amount, quantity of stationery, or percentage discount to be provided to the end user upon meeting the condition.

### BACKGROUND

1. Field of the Invention

This invention relates generally to the field of network data processing systems. More particularly, the invention relates to an improved architecture and method for managing promotions within an online stationery design system.

2. Description of the Related Art

Web-based systems for designing stationery such as wedding invitations, birth announcements, birthday party invitations, etc, are currently available over the Internet. As illustrated in FIG. 1, in current Web-based systems, a template designer 110 creates a static design template 120 for each type of stationery. The static design template 120 includes a plurality of text box regions 121, 122, 124 representing locations where text is to be displayed and potentially one or more image regions 124 representation locations where images uploaded by the user are to be displayed.

The static design template 120 is personalized via a Web-based user interface 130 made accessible to end users 111 over the Internet. The Web-based interface typically takes the form of a Web page which is downloaded to a client computer of the end user 111. The Web page includes a plurality of text entry fields 131, 132, 134 which correspond to the text box regions 121, 122, 124 within the design template, respectively. The Web page may also include one or more image entry fields 133 corresponding to the image regions 123 of the static design template 120. Images may be uploaded to the image entry field 133 and positioned within the image region 123 of the design template 120.

Some Web-based systems for designing stationery are capable of supporting promotions which include discounts on particular products, orders, shipping methods, etc, over a specified period of time. One problem with the promotion implementations on current Web-based stationery systems, however, is that they are hard-coded for each individual stationery product and, consequently, do not scale well for a large number of stationery products. For example, as illustrated in FIG. 2, promotion 231 is associated with stationery product 221; promotion 232 is associated with stationery products 222 and 223; and promotion 233 is associated with stationery product 223. Thus, when a new promotion is run, it must be manually associated with existing stationery products based on, for example, the attributes of those products. For example, if a promotion is for 10% off all cards using a particular printing technology (e.g., digital press cards), all of the stationery products associated with this type of printing must be manually identified and linked to the promotion. Manual associations of this nature require a significant amount of time and may result in errors (e.g., a particular stationary product may not be identified and/or the wrong stationery products may be identified).

Accordingly, what is needed is an improved system for designing and generating online stationery. What is also needed is an improved system and method for managing promotions within an online stationery design system.

### SUMMARY

A system and method are described for managing promotions within an online stationery service. For example, a system implemented in accordance with one embodiment of the invention comprises a promotions engine for creating and managing promotions related to online stationery, the promotions engine comprising: a plurality of promotion rules associated with a plurality of stationery promotions, each of the promotion rules comprising one or more condition objects and one or more clause objects, each of the condition objects comprising at least a specified condition level variable, the condition level variable having a plurality of selectable options including an order level and an item level, wherein order level indicates that the condition is applicable to an entire online stationery order and item level indicates that the condition is applicable to a particular stationery item or group of related items, wherein each condition level has a value associated therewith to indicate a minimum dollar amount or quantity of stationery to meet the condition; each of the clause objects comprising at least a specified clause level variable, the clause level variable having a plurality of selectable options including an order level and an item level, wherein order level indicates that the clause is applicable to an entire stationery order and item level indicates that the clause is applicable to a particular stationery item or group of related items, wherein each clause level has a value associated therewith to indicate a dollar amount, quantity of stationery, or percentage discount to be provided to the end user upon meeting the condition.

### BRIEF DESCRIPTION OF THE DRAWINGS

A better understanding of the present invention can be obtained from the following detailed description in conjunction with the following drawings, in which:

FIG. 1 illustrates a prior art system architecture for generating online stationary.

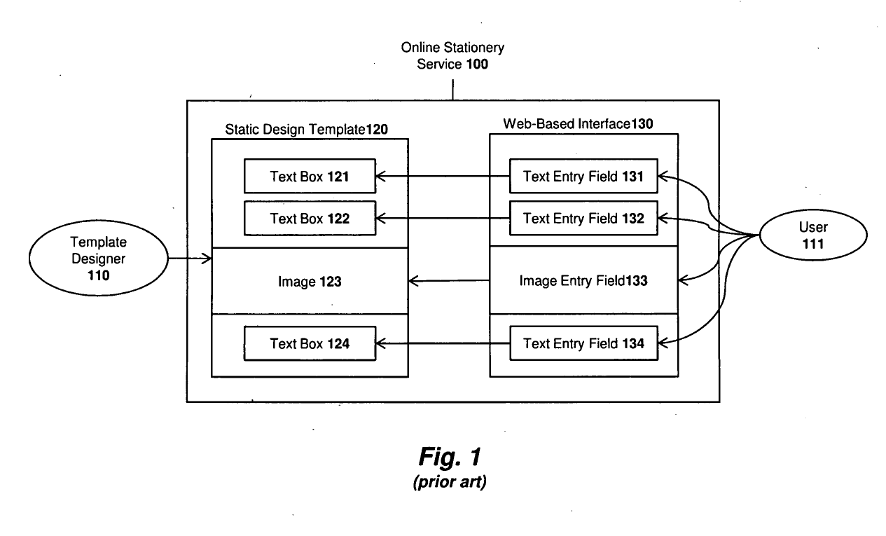

FIG. 2 illustrates a prior art system in which pricing structures are associated with stationery products.

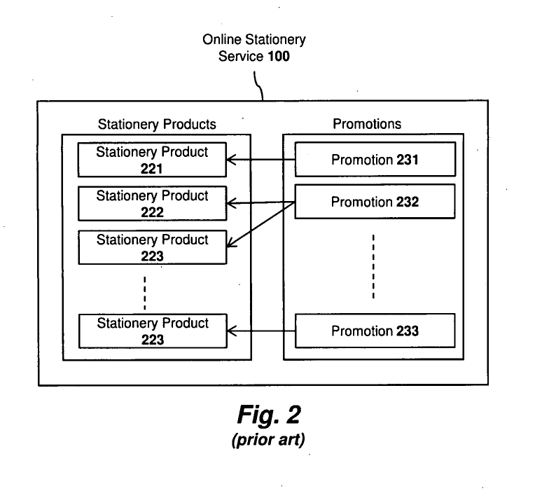

FIG. 3 illustrates one embodiment of a system for implementing promotions within an online stationery service.

FIG. 4 illustrates variables for setting clauses and conditions according to one embodiment of the invention.

FIG. 5 illustrates tiers and sub-types used for clauses and conditions according to one embodiment of the invention.

FIG. 6 illustrates one embodiment of a Web-based graphical user interface (GUI) for creating and/or editing a promotion rule.

FIG. 7 illustrates one embodiment of a Web-based GUI for creating and/or editing conditions.

FIG. 8 illustrates one embodiment of a Web-based GUI for generating promotion codes.

### DETAILED DESCRIPTION OF PREFERRED EMBODIMENTS

Described below is a system and method for managing quantity tiers using attributes in an online stationery system. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

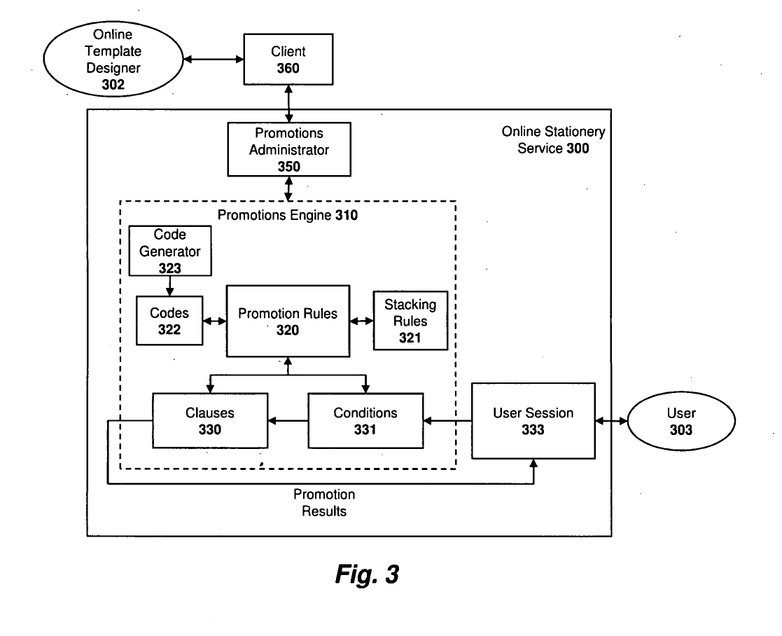

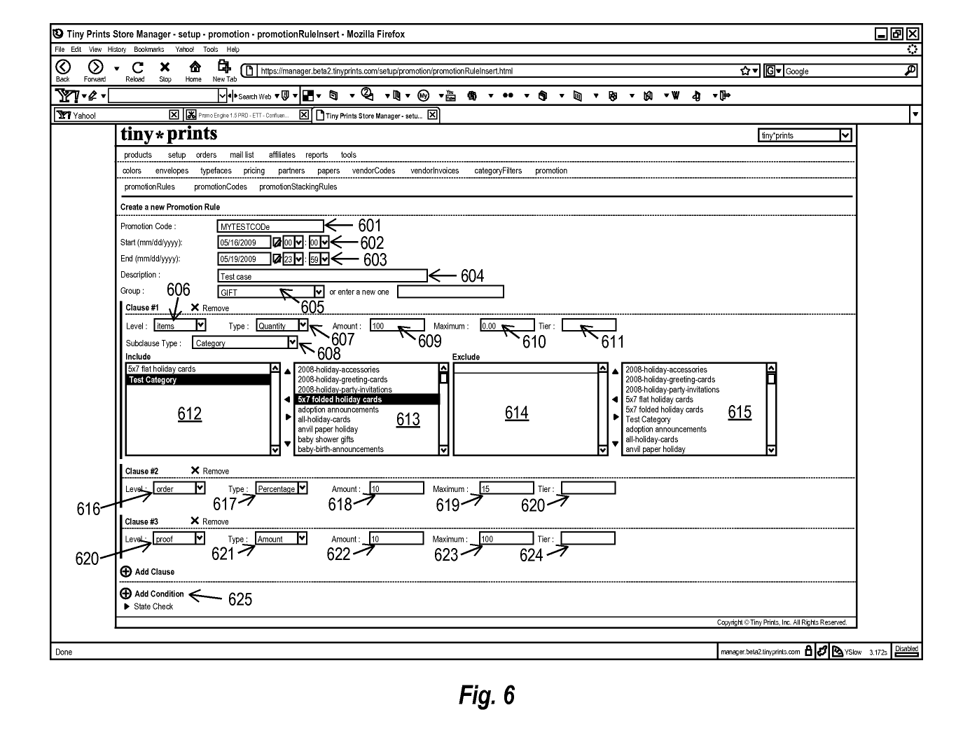

FIG. 3 illustrates a promotions engine 310 implemented in one embodiment of the invention which includes a plurality of promotion rules 320 for a plurality of promotions. In one embodiment, each “promotion” is implemented using a single promotion rule 320 (although in alternate embodiments, a promotion may be comprised of multiple promotion rules). As indicated in FIG. 3, the promotion rules 320 are created and edited via a promotions administrator module 350 executed on the online stationery service 300. In one embodiment, the promotions administrator 350 generates the Web-based graphical user interface (GUI) described below to enable an online template designer 302 or other administrator on the online stationery service 300 to enter/edit promotions via a Web browser on a client computer 360 (see, e.g., FIGS. 6-8).

In one embodiment of the invention, each promotion rule 320 is comprised of a set of conditions 331 and clauses 330. The conditions 331 specify the circumstances under which a user is to receive the benefits of a promotion and the clauses 330 specify the benefits to be received by the user if the circumstances have been met. By way of a simple example, the conditions may specify that a user is to receive 10% off of a particular item if the user purchases $100 or more in an order on the online stationery service 300. In this example, the condition is an order totaling $100 or more and the clause specifies 10% off of the particular item (upon the condition being met). Various additional details associated with conditions and clauses are set forth below

The promotions engine 310 also includes a set of stacking rules 321 which specify those promotion rules 320 which may be combined (or “stacked”) and those rules which are mutually exclusive. In one embodiment, each rule is assigned to a particular group of rules and rules within the same group are designated “non-stackable” (i.e., not combinable) by default. This has the effect of limiting the discount which the user may receive for a group of promotion rules. For example, if promotion rule A specifies 25% off orders from a particular stationery designer; promotion rule B specifies 15% off orders using a particular printing technique; and promotion rule C specifies 15% off orders over $100, it will typically be undesirable to allow the user to combine each of the different promotions (i.e., to receive a discount of 55% on a particular order). Consequently, the default behavior of the promotions engine 310 is to allow the implementation of only one rule within a group of promotion rules 320.

In one embodiment, in response to the user entering promotion codes from a series of promotions, the promotions engine 310 will automatically select the one which provides the greatest benefit to the end user and will notify the user that the remaining promotions are unavailable. Alternatively, or in addition, the promotions engine 310 may allow the user to manually select one of the promotions a particular promotion rule from the set of promotions. Manual selection may be appropriate in circumstances where one or more of the rules provide benefits other than a discounted price (e.g., if one rule provides a certain amount of free merchandise and another rule provides a certain percentage off, the choice of a particular rule is not as simple as an objective calculation).

In some cases, however, it may be desirable to allow some promotion rules 320 within the same group to be stackable. In one embodiment, this behavior of rules is specified within stacking rules 321. For example, the stacking rules 321 may specify that promotion rule A and promotion rule B are stackable, notwithstanding the fact that they are in the same group. Consequently, if the user has already selected promotion rule A, he/she may add promotion rule B and vice-versa; but the user may not add promotion rule C (unless C is also designated as stackable along with A and/or B).

In one embodiment, rules from different groups are stackable by default. Three groups are employed in one embodiment of the invention: “merchandise;” “gift;” and “magazine.” “Merchandise” is a group in which promotion rules discount the purchase price of an item, order or shipping, either through a percentage (e.g., 10% off) or a certain dollar amount (e.g., $10 off). “Gift” is a group in which promotion rules provide the end user an additional amount of free merchandise (e.g., “buy 25 and receive 5 free”). “Magazine” is a group in which free subscriptions are offered for magazines. Because promotion rules are stackable across groups by default, promotion rule A from group “Merchandise,” promotion rule B from group “Gift,” and promotion rule C from group “Magazine” may all be combined and used simultaneously. If certain promotion rules from different groups are not meant to be stackable, this information may also be specified within the stacking rules 321. While specific promotion groups are described above for the purposes of illustration, it should be noted that the underlying principles of the invention are not limited to these specific promotion groups.

As illustrated in FIG. 3, one embodiment of the invention also includes a promotion code generator 323 for generating a series of promotion codes 322 to identify promotion rules. The promotion codes may then be communicated to end users via email, the Internet, or through various forms of print media (e.g., magazines).

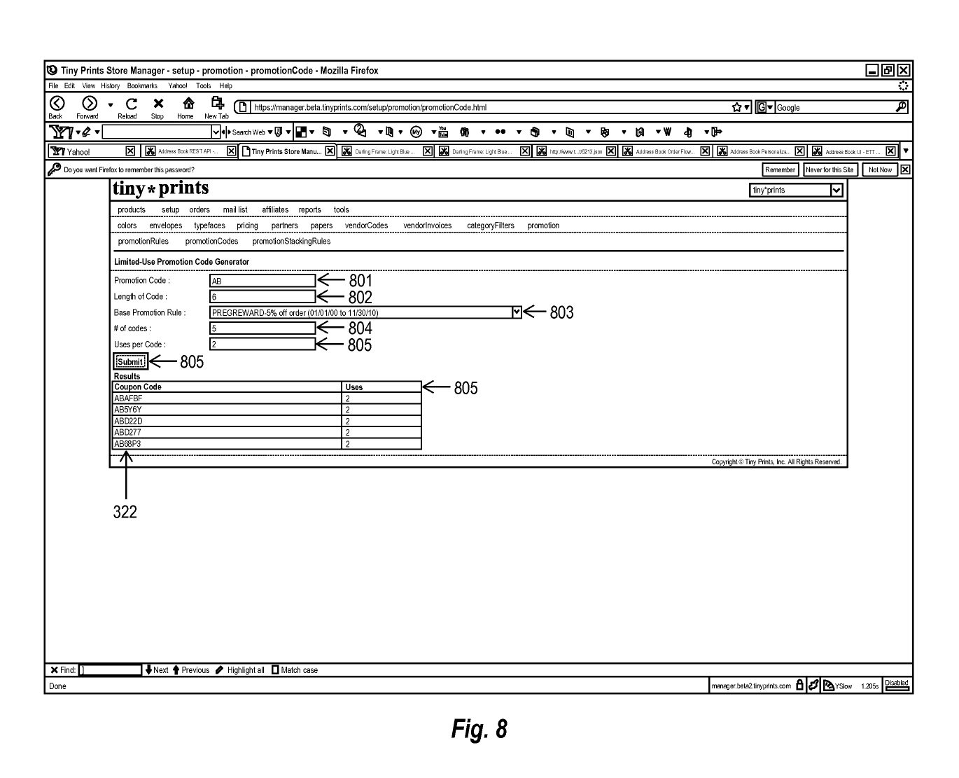

FIG. 8 illustrates a Web-based GUI for controlling the code generator 323. The online template designer 302 (or other administrator) may generate a set of promotion codes by specifying a coupon code within a coupon code data entry field 801. Each promotion code 322 generated by the code generator 323 will include the alphanumeric characters entered within the coupon code field 801 (“AB” in the example), thereby providing a simple mechanism for determining which codes below to which promotions. A desired code length is specified in data entry field 802; the promotion rule which the promotion codes will identify is selected within a drop-down menu 803; the number of codes to be generated is specified in data entry field 804; and the number of times a code may be used is specified in data entry field 805. The resulting set of codes 322 generated by the code generator 323 in response to selection of a “submit” button 806 are displayed within a table 807, as illustrated.

The code generator 323 uses the information entered by the online template designer 302 to generate the set of promotion codes 322 within the table 807. As illustrated, each of the codes starts with the coupon code value specified within data entry field 801 (“AB” in the example). In one embodiment, the code generator 323 randomly (rather than sequentially) generates a set of codes to be appended to the end of the coupon code value to generate a set of unique promotion code values. Random generation makes it more difficult for an unauthorized user to guess the value of one or more of the promotion codes. Since the length of code is specified as 6 in the example shown in FIG. 8, an additional 4 characters are appended to the end of the 2 character coupon code “AB.” Since the number 5 is entered in data entry field 804, 5 different promotion codes are generated. Each promotion code in the example shown in FIG. 8 may be used twice. After a code is used two times on the online stationery service 300, it is no longer valid. Once the codes are generated, they may be transmitted to end users via email, the Internet (e.g., via the online stationery service 300 website) or through print media.

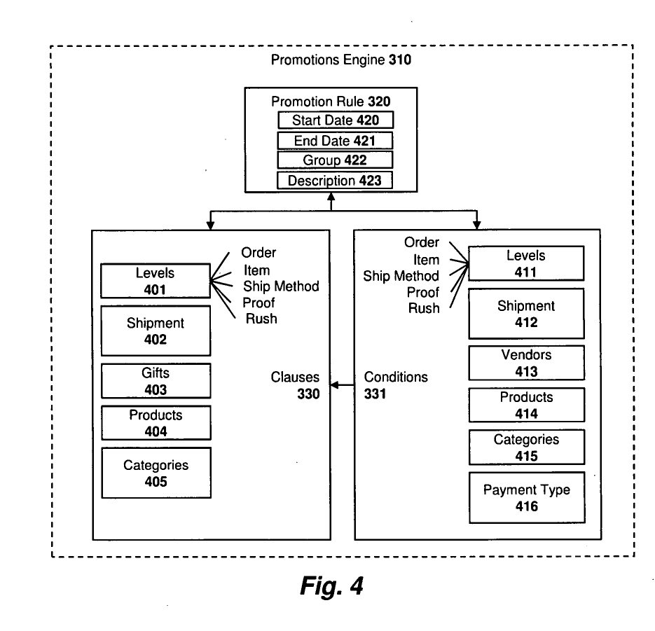

FIG. 4 illustrates additional details associated with promotion rules 320, conditions 331 and clauses 330. As illustrated, each promotion rule 320 includes a start date 420, end date 421, group 422 and description 423. The start and end dates designate the period of time that the promotion rule is in effect. “Group” specifies the group to which the promotion rule belongs and “description” comprises a textual description of the promotion.

Each condition 311 is specified using a plurality of selectable variables including a condition level 411, shipment method 415, vendor 413, product 414, stationery category 415 and payment type 416. In one embodiment, the condition level is used as the primary variable for specifying a condition and one or more of the other variables are used as sub-conditions to the level variable. As indicated in FIG. 4, the different condition levels employed in one embodiment of the invention include: order level, item level, shipping method level, rush level, and proof level.

At the order level, the condition is evaluated according to the entire order placed by a user. The order may be evaluated according to either the dollar amount of the entire order (e.g., orders over $100) or the quantity ordered by the end user (e.g., 100 units of a particular stationery product).

If item level is selected, a condition is evaluated for specific items (e.g., all digital press cards) rather than for the entire order. Like the order level, the item level is evaluated based on either a specific dollar amount (e.g., $100 of digital press cards) or a specific quantity (e.g., 100 units of digital press cards).

Shipping method level indicates that the condition is evaluated based on a specific type of shipping method such as, for example, UPS 2^{nd} day air, UPS ground, US postal service, FedEx next day air, etc. Typically, a condition is met if a specified type of shipping is selected.

One embodiment of the online stationery service 300 will allow the user to review a proof of the stationery design prior to placing a full order. “Proof” level sets a condition which is triggered upon the user requesting a proof of a stationery design. For example, the proof level may be used to trigger a clause to reimburse the end user for the cost of the proof upon placing the final order.

One embodiment of the online stationery service 300 provides an internal review process of the personalized stationery created by an end user. The user may request a rush on this process (typically for a small fee). “Rush” level sets a condition which is triggered upon the user requesting a rush on a stationery order. For example, the rush level may be used to trigger a clause to reimburse the end user if certain other conditions are met.

The other variables shown in FIG. 4, which may be used as sub-conditions to the levels 411 include shipment method 412 to identify particular method for shipping stationery to the end user; vendor 413 for identifying a particular stationery vendor; products 414 for identifying specific stationery products; categories 415 for identifying specific categories of products (e.g., “all 2009 holiday cards”); and payment type 416 for identifying a specific method of payment (e.g., Visa, Mastercard, American Express, etc). As described below, these condition variables may be combined in various ways to establish a set of conditions for a rule.

The clauses 330 include a similar set of levels described above with respect to conditions, with the primary difference being that the clause levels specify the benefit to be provided to the end user when the conditions 331 have been met. For example, at the order level, the user may receive a percentage discount on an order (e.g., 10%) or a specified dollar amount off of an order (e.g., $10). At the item level, the user may receive a percentage discount limited to a particular item or group of items, a specified dollar amount off, or a specified quantity of free merchandise (e.g., 100 free units of the item). At the shipment method level, the user may receive a shipping upgrade, reduced shipping or free shipping. At the proof and rush levels, the user may receive reimbursement for proof/rush requests, among other possible benefits. It should be noted, however, that these specific examples are merely for the purpose of illustration. The underlying principles of the invention are not limited to any particular set of benefits conferred upon an end user.

The other clause variables shown in FIG. 4 include shipment 402 to provide shipment upgrades, free shipping, and reduced shipping; gifts 403 to provide free merchandise; product 404 to specify particular stationery products; and categories 405 to specify particular categories of stationery.

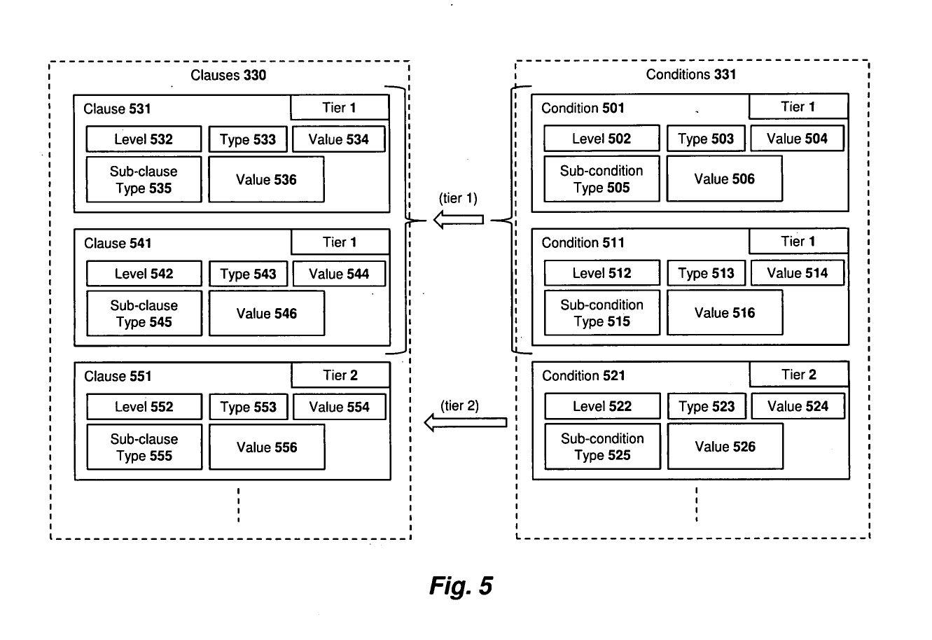

FIG. 5 illustrates additional details associated with the conditions 331 and clauses, including manner in which “tiers” are used within the promotions engine. Three different conditions 501, 511 and 521 are shown in FIG. 5, each having a specified level 502, 512, and 522, respectively; a level type 503, 513, and 523, respectively; and a value 504, 514, and 524, respectively. As described above, the level may be an order level, item level, shipping level, proof level or rush level. Type variables 503, 513, and 523 are provided to identify whether the level is characterized by a minimum quantity or a dollar amount. Finally, the values 504, 514, and 524 establish the numerical values for the minimum quantity or dollar amount (e.g., 100 units or $100, respectively).

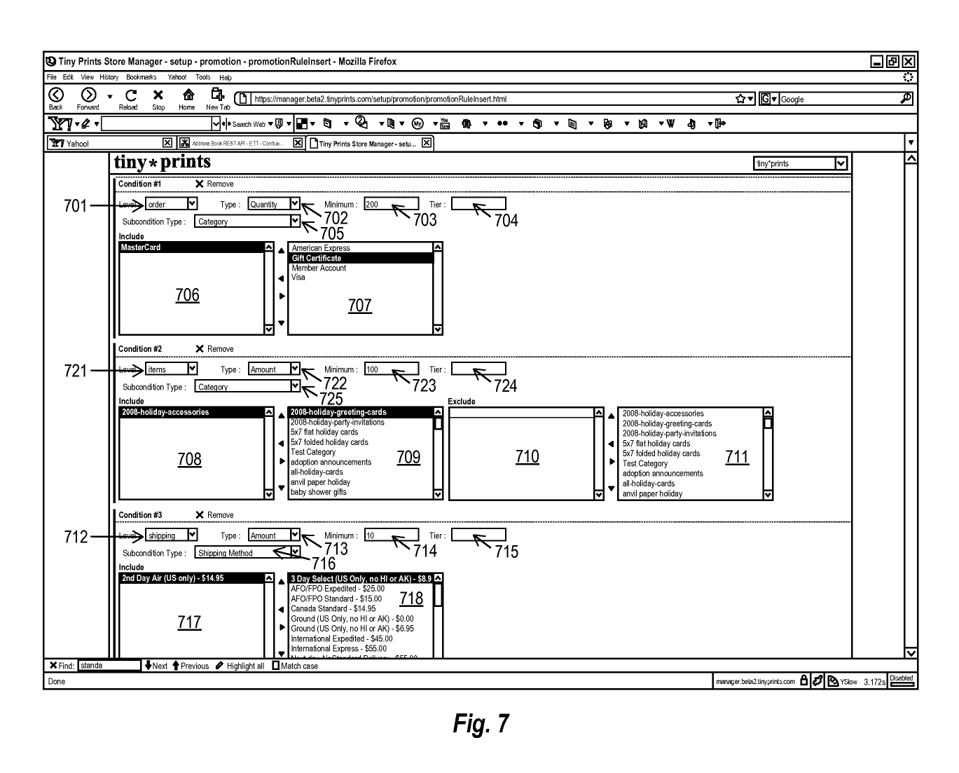

In addition, each of the conditions 501, 511, and 521 includes a sub-condition type 505, 515, and 525, respectively, and associated values 506, 516, and 526, respectively, to more precisely define each condition. By way of example, within condition 501, if an order level 502 is used, and a minimum dollar amount is established by type 503 and value 504, the sub-condition may specify that, in addition to the minimum order, the user must also use a certain payment type (e.g., Visa), or a certain stationery category (e.g., 5×7 holiday cards) in order to meet the condition. A virtually unlimited number of different sub-category types may be specified while still complying with the underlying principles of the invention, including those described with respect to FIG. 4. Some specific examples of sub-condition types are also shown in the Web-based GUI of FIGS. 6-7, described below. In one embodiment, in order to qualify for a benefit conferred by the clauses 330, all of the specified conditions 501, 511, and 521 (including sub-conditions 505, 515, and 525) must be met.

As illustrated in FIG. 5, clauses 531, 541, and 551 include a similar structure to the conditions 501, 511, and 521. Specifically, clauses 531, 541, 551 each specify a clause level 532, 542, and 552, respectively; a level type 533, 543, and 553, respectively; and a value 534, 544, and 554, respectively. As described above, the clause level may be an order level, item level, shipping level, proof level or rush level. Type variables 533, 543, and 525 are provided to identify whether the level is characterized by a percentage discount, a dollar amount discount, and/or a quantity of free merchandise. Finally, the values 534, 544, and 554 establish the numerical values for the percentage or dollar amount (e.g., 10% off or $10 off) or quantity (e.g., 100 free cards).

In addition, some of the clauses 531, 541, and 551 includes a sub-clause type 535, 545, and 555, respectively, and associated values 536, 546, and 556, respectively, to more precisely define each clause. By way of example, within condition 531, if an item level 532 is used, and a quantity of 10 units is established by type 533 and value 534, the sub-clause 535 and value 536 may specify the particular categories of stationery that the user may receive for free. As described below with respect to FIGS. 5 and 6, one embodiment of the invention provides user-modifiable “include” lists and “exclude” lists for including and excluding certain categories of stationery, certain stationery products, certain payment types, and certain shipping methods.

Table A below illustrates different levels, conditions/sub-conditions, and corresponding clauses/sub-clauses employed in one embodiment of the invention. It should be noted, however, that the underlying principles of the invention are not limited to these specific variables.

TABLE A

| | Conditions/Sub- | |
|---|---|---|
| Level | conditions | Clause/Sub-clause |
| Order | Order total, payment | Dollars off, percentage off, |
| | type | quantity discount |
| Item | Category, vendor and | Category, vendor and |
| | products | products |
| Shipping | Ship method | Ship method, shipping |
| | | upgrade |
| Rush | Rush processing | Rush free or discounted |
| | requested | |
| Proof | Proof requested | Ship free or discounted or |
| | | free ship upgrade |
| Gift | N/A | Free qty; non-personalized |
| | | cards, box sets, etc |
| Collections | N/A | Category, vendor, |
| | | products (like item but only |
| | | valid on certain set of |
| | | items) |

In Table A, “category” comprises a stationery category or sub-category (e.g., wedding invitations, boy birth announcements, etc) and “vendor” comprises the identity of the stationery designer and/or merchant selling the stationery design. “Products” comprise specific stationery products (e.g., specific birth announcement or wedding invitation designs). A “collection” is a specific group of related stationery, typically having the same basic design. For example, cards of two different sizes represent two different stationery “products,” but if they share then same basic design, they may be categorized within the same “collection.”

In addition, each condition and clause illustrated in FIG. 5 is associated with a particular tier. In particular, conditions 501 and 511 and clauses 531 and 541 are associated with “tier 1,” and condition 521 and clause 551 are associated with “tier 2.” The tiered arrangement is used in one embodiment of the invention to link different conditions to different clauses within the same rule. The tiered architecture may be used is to provide increasing benefits for larger purchase amounts within the same promotion rule. By way of example, tiers allow a single rule to provide a 10% discount for purchases over $100; a 15% discount for purchases over $200; and a 20% discount for purchases over $300. To implement this example a first condition/clause combination will be configured at a first tier to provide the 10% discount; a second condition/clause combination will be configured at a second tier to provide the 15% discount; and a third condition/clause combination will be configured at a third tier to provide the 20% discount.

In one embodiment, when implementing a tiered rule, the promotions engine 310 will check the conditions for each tier until the order fails to qualify. It will then select the highest tier which qualifies and evaluate the clauses at that tier. As illustrated in FIG. 5, tiers are numbered using a sequence of integers. Although the examples described above use tiers with similar clauses/conditions, tiers do not have to have similar clauses or conditions to comply with the underlying principles of the invention; the clauses/conditions may be completely different. In one embodiment, a message is provided to the end user if the user is close to entering into the next tier (e.g., “if you order $5 more, you will be entitled to an additional 5% discount”).

FIGS. 6-7 illustrate one embodiment of a Web-based GUI for creating and editing promotion rules. FIG. 6 illustrates a series of data entry fields and other graphical elements for creating a new promotion rule. A promotion code may be entered in data entry field 601 for the new promotion rule. In one embodiment, the promotion code corresponds to the coupon code entered in data entry field 801 to generate the series of promotion codes 322 as shown in FIG. 8. Data entry fields and drop-down menus 602 and 603 are provided for entering a promotion start date and end date, respectively. A description field 604 is provided for entering a description of the promotion. A drop down menu 605 is provided for specifying a group with which the new promotion rule will be associated (“Gift” is selected in the example).

Data for three different clauses is shown in FIG. 6. Several of the graphical elements shown in FIG. 6 are used to collect and populate the data objects shown in FIG. 5, including the clause level, type, value, and the sub-clause type and value. For example, the region for clause 1 includes a drop down menu 606 for specifying a clause level. As mentioned above, clause levels may include order level, item level, shipping level, proof level and rush level. A second drop down menu 607 is provided to specify the type of data which is provided within an amount data field 609. In one embodiment, different type options are provided for different clause levels. For example, the types for an “item” level may include “quantity” (indicating a number of units to be given to the end user); “amount” (indicating a dollar amount to be given); and/or “percentage” (indicating a percentage off of the item). Thus, the number entered into the amount field 609 will either be a quantity, amount or percentage, depending on the selection made in the drop down menu 607. In the example shown in FIG. 6, “quantity” is selected as the type for clause 1 and 100 is selected as the amount. Data entry field 610 allows a maximum dollar amount to be specified and data entry field 611 allows a tier to be specified. As mentioned above, successive integer values may be used to represent different tiers. Corresponding integer values are then entered for each of the conditions which correspond to the clauses (see FIG. 7).

A sub-clause type drop down menu 608 is provided to allow selection of a sub-clause type for clause 1. In the example shown in FIG. 6, the “category” sub-clause has been selected. An include list 612 is provided to identify stationery categories to be included in the clause and an exclude list 614 is provided to identify stationery categories to be excluded from the clause. Categories for the include list 612 are selected from a first listing of available categories 613 and categories for the exclude list 614 are selected from a second listing of available categories 615. Categories are selected from each of the first and second listings by highlighting one or more of the categories and then selecting a selection arrow. In the embodiment shown in FIG. 6, the selection arrow for selecting categories is pointed to the left and the selection arrow for de-selecting categories (i.e., removing them from the include/exclude lists) is pointed to the right.

In one embodiment, either the include list or the exclude list are used, but not both. For example, if categories are added to the include list, then only those items added to the list are included in the clause (i.e., items do not need to be added to the exclude list to be excluded). By contrast, if categories are added to the exclude list, then only those items will be excluded from the clause. All categories not on the exclude list will be included in the clause.

Two additional clauses are shown in FIG. 6, each with a drop-down menu 616, 620 for selecting a clause level; a drop-down menu 617, 621 for selecting the type of data which is provided within corresponding amount data field 619, 623; and a tier field 620, 624 for specifying a tier for each clause. In one embodiment, if the tier fields are left blank, then tiers are not used within the rule. Also shown is a link 625 which, when selected, provides data fields and other graphical elements for entering one or more conditions as shown in FIG. 7.

Data for three different conditions is shown in FIG. 7. As with the clauses described above, several of the graphical elements shown in FIG. 7 are used to collect and populate the data objects shown in FIG. 5, including the condition level, type, value, and the sub-clause type and value. For example, the region for condition 1 includes a drop down menu 701 for specifying a condition level. As mentioned above, conditions levels may include order level, item level, shipping level, proof level and rush level. A second drop down menu 702 is provided to specify the type of data which is entered within a minimum amount data field 703. In one embodiment, the minimum amount data field 703 specifies the minimum dollar or number of stationery units which must be ordered in order to qualify for the condition. If the type field 702 specifies a quantity, then the value in the data entry field 703 indicates a minimum quantity; if the type field 702 specifies an amount, then the value in the data entry field 703 indicates a minimum dollar amount.

In the specific example shown in FIG. 7, the first condition specifies an order level 701 with a minimum quantity value of 200 and specifies a sub-condition type 705 of “payment type.” Under the sub-condition type is an “include” list 706 which is populated by selecting options from an options list 707 (as described above with respect to FIG. 6). In the example shown in FIG. 7, the include list includes “Mastercard” for the payment type, meaning that the condition applies if a user purchases a minimum amount of 200 units and uses a Mastercard to make the purchase.

Condition 2 is an item level condition as specified by drop-down 721 in which a minimum dollar amount of $100 is specified via fields 722 and 723. An include listing 708 and an exclude listing 710 are provided. As described above the listings 708 and 710 are populated by selecting options from options listings 709 and 711, respectively. In the example shown in FIG. 7, a sub-condition type of “category” is selected via drop-down menu 725 and “2008 Holiday Accessories” is provided within the include list 708. The end result is that a purchase of $100 or more of any products from the 2008 Holiday Accessories category meets the condition.

Condition 3 employs a shipping level type as specified in drop-down 712 and sets a minimum dollar amount of $10 using drop down 713 and data entry field 723. A sub-condition type of “shipping method” selected via drop-down 716 and include list 717 specify a particular shipping method (2^{nd} Day Air in the example). As in prior examples, an options list 718 provides a listing of available shipping methods which may be moved into the include list 717. Thus, in the example shown in FIG. 7, any orders which employ 2^{nd} Day Air and which are over $10 meet the requirements of the condition.

The conditions also include “tier” data entry fields 704, 724, and 715 for entering an integer value linking the conditions to a particular tier (and to a clause at the same tier). Tiers are described above with respect to FIG. 5.

In one embodiment, each of the specified conditions must be met to trigger a clause (i.e., the conditions are combined using a logical AND operation). Alternatively, the conditions may be combined using a logical OR operation such that any one of the conditions may trigger a clause; or may be combined using a combination of ANDs and ORs.

Throughout the discussion above, various details have been omitted to avoid obscuring the pertinent aspects of the invention. For example, in an embodiment of the invention in which the user connects to the online stationery service 300 via a Web browser, various well known functional modules associated within the user session logic 333 and promotions administrator logic 350 shown in FIG. 3 are executed to receive input, process the input and dynamically generate Web pages containing the results. The Web pages may be formatted according to the well known HyperText Markup Language (“HTML”) or Extensible HTML (“XHTML”) formats, and may provide navigation to other Web pages via hypertext links. Web pages are requested, dynamically generated, and transmitted from Web servers on the online stationery service 300 using the Hypertext Transfer Protocol (HTTP). One embodiment of the invention employs application software written in PHP (a well known scripting language designed for producing dynamic web pages) running on Apache™ Web servers served off Linux platforms. In addition, in one embodiment, the databases described herein are MySQL databases. It should be noted, however, that the underlying principles of the invention are not limited to any particular type of communications protocol or network architecture.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, it will be readily apparent to those of skill in the art that the functional modules such as wizards and other logic may be implemented as software, hardware or any combination thereof. Accordingly, the scope and spirit of the invention should be judged in terms of the claims which follow.

What is claimed is:

1. A system implemented within an online stationery service comprising, the system comprising at least one memory for storing program code and at least one processor for processing the program code to execute:
a promotions engine for creating and managing promotions related to online stationery, the promotions engine comprising:
a plurality of promotion rules associated with a plurality of stationery promotions, each of the promotion rules comprising one or more condition objects and one or more clause objects, the clause objects specifying one or more benefits to be conferred upon an end user and the condition objects specifying one or more conditions which must be met for the benefits to be conferred upon the end user;
each of the condition objects comprising at least a specified condition level variable, the condition level variable having a plurality of selectable options including an order level and an item level, wherein order level indicates that the condition is applicable to an entire online stationery order and item level indicates that the condition is applicable to a particular stationery item or group of related items, wherein each condition level has a value associated therewith to specify the requirements of the condition;
each of the clause objects comprising at least a specified clause level variable, the clause level variable having a plurality of selectable options including an order level and an item level, wherein order level indicates that the clause is applicable to an entire stationery order and item level indicates that the clause is applicable to a particular stationery item or group of related items, wherein each clause level has a value associated therewith to indicate a benefit to be conferred upon the user upon meeting the requirements of the condition.

2. The system as in claim 1 wherein one or more of the condition objects comprises a subcondition type having a plurality of selectable options derived from the selected condition level, wherein in response one of the selectable options being selected, the condition is only met if the subcondition type requirements are met in addition to the requirements of the condition level.

3. The system as in claim 2 wherein one or more of the clause objects comprises a subclause type having a plurality of selectable options derived from the selected clause level, wherein in response one of the selectable options being selected, the benefit conferred on the user is based on the subclause type in addition to the clause level and associated value.

4. The system as in claim 3 wherein the subcondition type comprises payment type indicating a form of payment, a stationery category indicating a predefined category of stationery, and/or a shipping method type indicating a shipping method.

5. The system as in claim 4 wherein the subclause type comprises a stationery category indicating a predefined category of stationery.

6. The system as in claim 5 wherein values for some of the subcondition types and subclause types are selected with include lists and/or exclude lists, wherein items on the include list indicate that those items are to be included in the subcondition or subclause and wherein items on the exclude list indicate that those items are to be excluded from the subcondition or subclause.

7. The system as in claim 1 further comprising:
a plurality of stacking rules indicating which of the promotion rules may be combined and which of the promotion rules may not be combined.

8. The system as in claim 7 wherein each promotion rule is associated with a particular group and wherein promotion rules within the same group are not combinable unless explicitly specified as such within the stacking rules.

9. The system as in claim 1 further comprising a promotion code generator to receive a coupon code, a designated length of the code, a number of codes to be generated, and a number of times each code may be used and to responsively generate a set of promotion codes each having a first portion comprised of the coupon code and a second portion comprising a randomly generated sequence of alphanumeric characters, each of the promotion codes having a length equal to the designated length of the code.

10. The system as in claim 1 wherein for an order level and/or item level the value indicates a minimum dollar amount or quantity of stationery to meet the requirements of the condition and wherein the value of the clause level comprises a dollar amount, quantity of stationery, or percentage discount to be provided to the end user upon meeting the condition.

11. The system as in claim 1 wherein each of the condition objects and each of the clause objects is assigned a particular tier value, wherein each condition object at a particular tier is associated with a clause at that particular tier.

12. The system as in claim 11 wherein each clause at each tier comprises a different level of benefit to confer upon an end user, and wherein, in response to a user placing an order, a tier is automatically selected to provide the user with the greatest available benefit.

13. A system comprising a memory for storing program code and a processor for processing the program code to generate a Web page having a graphical user interface (GUI), the GUI comprising:
a first region having data entry fields for specifying a promotion rule, including a start date, an end date and a name;
a second region having data entry fields for specifying conditions which must be met for the benefits to be conferred upon the end user under the promotion rule, each condition being defined in a sub-region within the second region, wherein each condition region comprises a data entry field for specifying a condition level variable, the condition level variable having a plurality of selectable options including an order level and an item level, wherein order level indicates that the condition is applicable to an entire online stationery order and item level indicates that the condition is applicable to a particular stationery item or group of related items, wherein each sub-region for each condition includes a data entry field for specifying a condition level value to specify the requirements of the condition;
a third region having data entry fields for specifying a benefit to be conferred upon an end user, each clause being defined in a sub-region within the third region, each of the clauses comprising at least a specified clause level variable, the clause level variable having a plurality of selectable options including an order level and an item level, wherein order level indicates that the clause is applicable to an entire stationery order and item level indicates that the clause is applicable to a particular stationery item or group of related items, wherein each sub-region for each clause includes a data entry field for specifying a clause level value to indicate a benefit to be conferred upon the user upon meeting the requirements of the conditions.

14. The system as in claim 13 wherein one or more of the data entry fields comprise drop-down menus comprising lists of selectable options.

15. The system as in claim 13 wherein each sub-region within the second region include selectable options for specifying a subcondition type and value, the subcondition type having a plurality of selectable options derived from the selected condition level, wherein in response one of the selectable options being selected, the condition is only met if the subcondition type and value requirements are met in addition to the requirements of the condition level.

16. The system as in claim 15 wherein each sub-region within the third region include selectable options for specifying a subclause type and value derived from the selected clause level, wherein in response one of the selectable options being selected, the benefit conferred on the user is based on the subclause type in addition to the clause level and associated value.

17. The system as in claim 15 wherein the subcondition type comprises payment type indicating a form of payment, a stationery category indicating a predefined category of stationery, and/or a shipping method type indicating a shipping method.

18. The system as in claim 16 wherein the subclause type comprises a stationery category indicating a predefined category of stationery.

19. The system as in claim 18 wherein values for some of the subcondition types and subclause types are selected with include lists and/or exclude lists contained within the sub-regions within the second region and/or the sub-regions within the third region, respectively, wherein items on the include list indicate that those items are to be included in the subcondition or subclause and wherein items on the exclude list indicate that those items are to be excluded from the subcondition or subclause.

20. The system as in claim 13 wherein the sub-regions within the second region and/or the sub-regions within the third region comprise a data entry field for specifying a tier, wherein each condition at a particular tier is associated with a clause at that particular tier.

21. The system as in claim 20 wherein each clause at each tier comprises a different level of benefit to confer upon an end user, and wherein, in response to a user placing an order, a tier is automatically selected to provide the user with the greatest available benefit.
